(19) United States
(12) Patent Application Publication
(10) Pub. No.: US 2003/0105879 A1
(43) Pub. Date: Jun. 5, 2003

(54) Wireless network architecture and method

(76) Inventor: Erlend Olson, Duarte, CA (US)

Correspondence Address: Fernandez & Associates, LLP, PO Box D, Menlo Park, CA, 94026-6402, US

(21) Appl. No.: 10/270,706

(22) Filed: Oct. 10, 2002

Related U.S. Application Data
(60) Provisional application No. 60/341,365, filed on Nov. 30, 2001.

(51) Int. Cl. G06F 15/16

(52) U.S. Cl. 709/246; 709/230

(57) ABSTRACT

A wireless network architecture is disclosed which effects substantial gains in security and efficiency. Data, graphics, or other data residing on a network server which is desired to be provided to the user of a wireless communication device (WCD) is formatted into an appropriate WCD display-compatible data by the wireless server, instead of by the WCD itself. For example, a “WCD display-compatible data” would be a matrix of pixel values, each value representing the intensity of illumination or reflection of a specific spot or pixel on the WCD screen, as it can be directly displayed on the WCD screen without interpretive processing by a WCD. Instead of a high cost and power-hungry operating system residing on the WCD, those processing capabilities are rendered by the wireless server, with the result that the functionality of the WCD can be made into a fixed hardware on the WCD.

### PRIORITY CLAIM

This application claims the benefit under 35 U.S.C. 119 (e) of the filing date of U.S. provisional application No. 60/341,365 entitled “System and Method for Wireless Data Communications” by Erlend Olson, filed on Nov. 30, 2001, owned by the assignee of this application and incorporated herein by reference.

### BACKGROUND INFORMATION

1. Field of the Invention

This invention pertains to wireless communications devices (WCDs) and also the architecture for communications and data flow between WCDs and networks and computers that serve them, and more specifically those WCDs and networks that employ a packet scheme for communications, and more specifically those systems that are oriented principally toward the two-way communications of text and graphical information and which may or may not include voice communications.

2. Description of Related Art

Presently the internet is being extended from connections between computers and servers which are wired into the internet, to include communications between computers and servers and portable wireless communications devices, or WCDs, herein understood generally to include any wireless communication devices such as PDAs, data-capable cell phones, wireless handheld computers and data-capable pagers. The architecture and structure of non-voice data that is communicated according to present standards and methods from the internet to the WCDs is such that the WCD is today required to have sophisticated computing and rendering capabilities, not unlike those available in a regular desktop or laptop computer. The requirements for the WCD typically include the ability to handle security, and decode and render one or more of the various languages used in the internet today such as HTML, XML, Java and others that are known to those familiar with the art of internet languages and graphics rendering. The requirements for the WCD typically also include the ability to render fonts and graphics and images in a form familiar to the user and able to provide relevant information that a user may want to view on a WCD. Those requirements in turn dictate that the WCD must have sophisticated processing capabilities, including often a state-of-the-art processor as well as a sophisticated operating system. The presence of such a processor able to perform rendering of internet languages, and an associated operating system, in the WCD then makes the WCD costly and power hungry, requiring large batteries, or frequent charging. The cost, size and sophistication of present day WCDs prevents them from being easily adopted by consumers, and thus prevents the so-called wireless internet from evolving beyond a limited market of high-end users and into the mass marketplace.

Furthermore, current day devices and applications that users and businesses desire to introduce to a wireless environment have a constant limitation as WCDs that are already deployed may not be capable of rendering information or graphics or data in the newer formats of evolving and ever-changing languages. Unlike computers that are wired into the internet, it is impractical to upgrade wireless devices over a network. For example, a user may possess a WCD capable of handling Java 1.0, but within a very short time, many wired internet sites may employ Java 2.0 or some other new language such as a new version of XML, WAP, etc. So the current day architecture and method for connecting WCDs to the internet not only results in a costly and power hungry device, it also results in deployed devices that can become quickly obsolete at worst, or at best require a significant investment in time and effort on the part of the users to upgrade their WCDs. Still further, the rollout of new mass consumer applications intended to communicate with a wide variety of WCDs is severely hampered and slowed as the applications providers have to perform extensive regression tests for all of the various types of WCD capabilities that may exist in their user base.

A further problem exists with the current architecture and structure of WCDs and the method of interfacing the network and other wired computers to those WCDs. The problem is that of a user communicating from the WCD to the network in a manner which the network can tolerate. Systems, composed of WCDs, wireless interface formats and languages and server interfaces, typically require the user to enter text in a manner which results in the transmission of ASCII-based characters back to the network to effect some task that the user desires, such as providing a web address, entering a number or command or entering a text message. This creates a serious problem for wireless portable devices which typically cannot tolerate a keyboard. Therefore the user is required to either pick characters from a menu provided on-screen, or the WCD is required to interpret natural printing or writing, or interpretive printing or writing, and convert it into a digital character suitable for use with present day systems. This puts a large burden on processing requirements on a WCD, as script recognition is a very demanding computing task. This drives up the cost and power consumption of WCDs designed in the current day method and embedded in the current day communications architecture even more.

A further problem with current day WCDs and WCD communications methods is the lack of unified security. Typically, the security in a WCD and WCD communications system today relies on various levels of security in each major process, with all the of the processes communicating more or less securely with each other. A particular problem exists with the WCD itself, which typically has an operating system. Operating systems by their very nature are easy targets for security attacks, as their purpose is to enable remote processes and processes instigated by users to have access to information and resources on the WCD. Because WCDs with operating systems typically hold and store sensitive information (such as bank account numbers, passwords and so on), and because WCDs are relatively easy to attack in isolation, and further because the typical WCD and WCD communications system today does not offer WCD-to-Server unified security, WCDs and their associated communications systems today are not suitable for applications requiring strong security, such as banking and commerce applications.

Finally, the cost and usage complexities of existing WCDs prevent the use of a deployment business model wherein the deployment of WCDs to enhance business and commerce transactions in a mobile or wireless environment is sponsored by a business, except in the most cost insensitive, and thus non-consumer, applications. For example, it is impractical today for a bank to pay for the deployment of a WCD to each of its customers, even though once deployed such a wireless communication method may substantially benefit both the bank and the customer, because typical WCDs capable of handling something as simple as checking a bank account balance cost hundreds of dollars. Therefore the deployment of consumer wireless internet applications is further hampered by the fact that businesses must generally wait for their customer base to be self-motivated to purchase multi-hundred dollar devices on their own.

The current apparatus and methods for communications with WCDs can be further understood by reference to FIG. 1, which represents a typical data flow and set of processes in a data or graphics application between a computer on the internet or other wired network and a wireless device on a packet network, such as 802.11, GPRS or 1xRTT. Referring to FIG. 1, for the case of direction of flow from an internet application to a WCD, the flow can be described as follows:

Information, data, or graphics, 101, is assembled by an application server, 201, into one or more sets of HTML, XML, Java, or other appropriate internet-compatible data, 102. As included herein “internet-compatible data” is understood generally to include data in the form of languages for use over the internet such as XTML, XML, Java, or Flash. The modules are then sent as a set of packets over an IP network, 103, to a wireless or aggregation server, 202, which performs routing of the packets, 104. The packets containing the internet-compatible data are then encapsulated with more or less security according to the operating network, 104 and 105, and then sent over a packet-based wireless link such as 802.11, GPRS, or 1xRTT by the wireless basestation, 203, according to the proper protocol applicable. The packets are received by the WCD, 204, on which the processor and associated operating system, 110 and 114, strip off security encapsulation, and then decode the packets of HTML, XML, Java, Flash, etc using stored or previously loaded fonts, 119, graphics objects, 116, user preferences, 113, and local memory, 118. The WCD also often contains special programs or locally stored reference data for rendering characters in the language appropriate for the user, 115. The results are then rendered on the display of the WCD, 111. The entire process of receiving packets, 108, stripping off security and assembling packets, 109, through the interpretation of the language embedded in the packets, 110, and the complex graphics rendering that requires a sophisticated processor and a host of imbedded reference information, 113-119, necessitates a high consumption of power and memory, 118, on the WCD, 204.

The limitations of the prior art are similarly apparent when communications between the WCD, 204, and the server, 201, are initiated. Information input by the user on the WCD through the use of a keypad, menu screen, or touch screen, are must be processed by the operating system, 114, and processor, 110, on the WCD, 204. For instance, if the user has employed a script-based entry method, the processor and operating system, 110 and 114, must convert the script into a digital character. The WCD processor and operating system, 110 and 114, then assemble one or more modules of pure text, graphics, and internet-compatible data into a data set inside the processor or memory, 110 or 118. The data set is then composed into packets according to the protocol of the communications network, such as 802.11 or 1xRTT, etc., and sent over the wireless link, 107, to the server, 201, which converts the wireless packets into IP packets suitable for transmission to the network or application server, 201.

### SUMMARY OF THE INVENTION

An advantage of the new invention described herein is that its use yields a dramatic reduction in the cost, power consumption and complication of a graphics-capable non-voice WCD. The features of the new architecture and WCD result in the reduction in cost of the WCD such that it becomes low enough cost for mass deployment, without compromising to any significance the functionality possible on it for the majority of uses for which a WCD might be used by consumers. Also, because of the dramatic cost reduction enabled by the new invention, the invention enables a new business model whereby it becomes reasonable that a business could provide a WCD to its customers free of charge, in order to enable further or enhanced business transactions with a consumer who would then possess a WCD that he or she would otherwise not possess. In the present invention, data, graphics, or other data residing on a network server which is desired to be provided to the user of a WCD is formatted as previously into an appropriate internet-compatible data, such as HTML, XML, Java, etc., by the processor in the network server. The internet-compatible data is then sent to a wireless server over a suitable connection, for example a wired interact connection. As included herein a “wireless server” is understood generally to include any computer with a processor, storage and one or more network connections, which either directly or through other servers or network packet routers eventually connects to the wireless base-station that transmits packets wirelessly to the WCD, and which is designed to provide resources, images, audio data or other internet-related content to a wireless device. It is understood that many servers may exist between the origination of the data and the wireless server. In the present invention, the wireless server now duplicates to large extent the processing that, in the prior art, is done by the WCD. As the ultimate goal of any packet transfer of information is to render a recognizable or understandable display to an end user, composed of graphics, text, or other information in human-readable form, the wireless server converts the internet-compatible data received from the network server into a WCD display-compatible data suitable for rendering on a WCD display. As included herein, “WCD display-compatible data” is understood generally to be data which in original and uncompressed form directly represents an image that can be displayed on the WCD, without conversion by the WCD from a more abstract format such as HTML, XML, WAP, and so on. For clarification by example, a WAP-compatible group of packets intended to cause the creation of an image on a WCD after processing by the WCD would not be considered “WCD display-compatible data” herein, as the packets containing the WAP information cannot be directly displayed on the WCD, and the WCD must convert the WAP into a graphical rendering before display. In contrast, an example of a “WCD display-compatible data” would be a matrix of pixel values, each value representing the intensity of illumination or reflection of a specific spot or pixel on the WCD screen, would be “WCD display-compatible data”, as it can be directly displayed on the WCD screen without interpretive processing.

The conversion of internet-compatible data into WCD display-compatible data is performed by the wireless server using an operating system, language information, font information, graphics figures and capabilities, and user preferences, and any other relevant and/or necessary information or processing as might be required to create an image, as would be obvious to those practiced in the art of graphics generation from internet and computer interface protocols and languages. Additionally, the wireless server may compress the WCD display-compatible data with a suitable compression algorithm, such as JPEG, a hadamard matrix decomposition, or other compression algorithm that results in the suitable compression of the image, such that when decompressed it results in an image compatible for display on the WCD. Additionally, since the image stored in memory might contain sensitive information, such as a bank account balance or other personal data, the wireless server could use information stored on the target WCD or a public key system to encrypt the image with a robust encryption such that if the image transmission to the WCD were intercepted, it would be difficult or impossible to decipher.

The WCD display-compatible data, which may additionally be compressed and encrypted, is then sent over a wireless link to a wireless base station server and transmitter for transmission to the target WCD, according to the suitable protocol employed for the wireless packet network. The WCD then receives the packets containing the WCD display-compatible data and performs a specific and minimal processing for display on the WCD. If necessary, the WCD decompresses and/or decrypts the WCD display-compatible data with fixed algorithms which are generally simple to make into fixed hardware on the WCD.

In the case where the user of the WCD desires to create a new piece of information, the processor records writing, printing, or touches on a touchscreen of the WCD. The WCD image created by the user may include locations of touchpoints on the screen, characters, or a handwritten image. When the user notifies the WCD hardware that it is ready to send the new WCD image to the wireless server, the image is converted into packets appropriate for the protocol of transmission over the wireless network, herein referred to as an “internet-compatible data.” In addition, before packet decomposition, the WCD image may be compressed and/or encrypted using same or similar image compression and data encryption algorithms as the algorithms used by the wireless server. The WCD image is then transmitted by the transceiver to the wireless basestation, which then sends the packets to the wireless server. The wireless server then reverses the process, converting the WCD image into an internet-compatible data, by assembling the packets, and, if necessary, decrypting and/or decompressing the encrypted and/or compressed WCD image. The internet-compatible data, now present on the wireless server, can be sent directly to the network server, or can be further processed by the server. In another action that is possible to take by the server, when it has received a set of WCD image packets, instead of decompressing the image completely, the server may discover through examination of headers, or partial decomposition of the packets, that the contained image is a message and that the message is intended for a recipient on the network who is also in possession of a WCD capable of decompressing the image itself. Therefore the server can simply forward the message directly to another WCD device.

### BRIEF DESCRIPTION OF THE DRAWINGS

FIG. 1 illustrates an architectural view of the prior art in wireless communications networks.

FIG. 2 illustrates an architectural view of the wireless communications network of the present invention.

FIG. 3 illustrates a block diagram of a single chip of the WCD hardware.

FIG. 4 illustrates a general flowchart of a method for transmitting data from a network server to a WCD.

FIG. 5 illustrates a block diagram of the contents of packets containing the WCD display-compatible data.

FIG. 6 illustrates a general flowchart of a method for transmitting data from a WCD to a network server.

### DETAILED DESCRIPTION OF PREFERRED EMBODIMENT(S)

This invention describes the method, apparatus and architecture of devices and communications methods between the wired internet as it exists today to a new kind of WCD device and communications architecture, using the existing and evolving wireless packet networks such as GPRS and 1xRTT and 802.11 as they were intended, and without disrupting the inherent communications protocols that such networks employ today. The techniques described herein may be employed as part of existing WCDs or cell phones or may be used in the construction and deployment of very low cost devices and communications methods that are not part of existing WCDs.

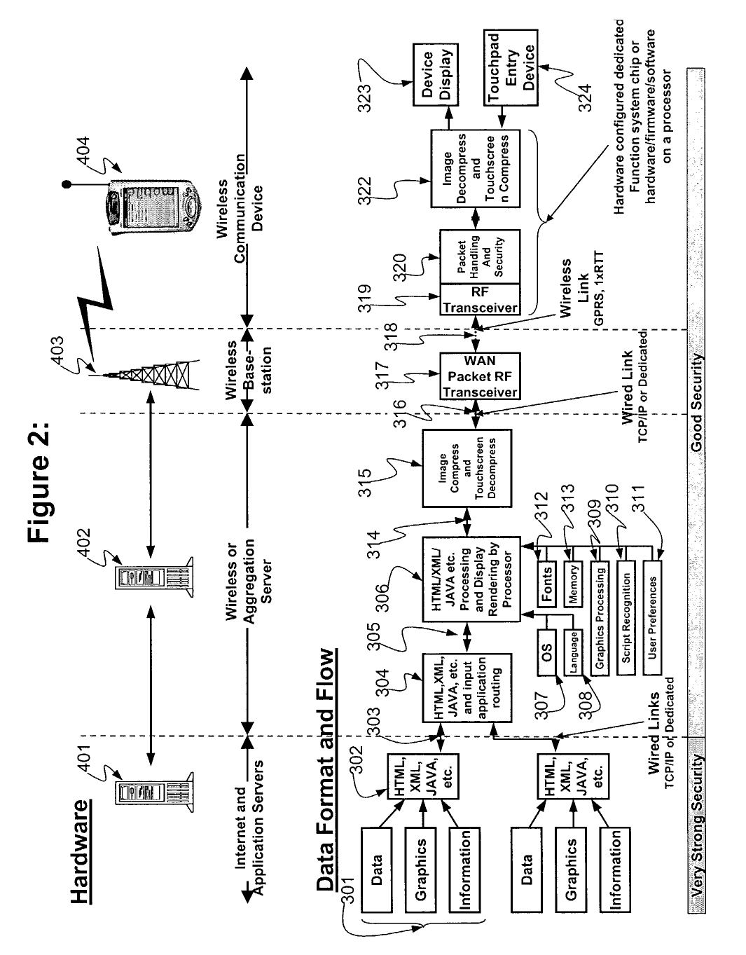

Referring to FIG. 2, the wireless network architecture comprises one or more wireless communications devices (WCDs), 404, a basestation, 403, coupled to the one or more WCDs, and a wireless server, 402, coupled to the base-station and a network server, 401. The wireless server, 402, is generally coupled to the network server, 401, and the basestation, 403, using one or more wireless links.

The wireless server, 402, performs routing of HTML, XML, Java, or other internet-compatible data as in the prior art, 304, as well as one or more processors, 306 & 315, that converts the internet-compatible data into WCD display-compatible data. The wireless server, 402, which is typically wall powered instead of battery powered, and which can have dramatically greater and faster processing power than a typical WCD, can comprise one or more servers, or can be a server not part of the wireless service company's equipment, such as an aggregation or other service provider's server. One processor, 306, comprises an operating system, 307, language information, 308, font information, 312, graphics figures and capabilities, 309, and user preferences, 311, and any other relevant and/or necessary information or processing as might be required to create a WCD display-compatible image, as would be obvious to those practiced in the art of graphics generation from internet and computer interface protocols and languages. The resulting WCD display-compatible image may be stored in memory, 313, for further processing if necessary. In addition, the wireless server comprises an other processor, 315, which comprises processes for compression and decompression of the WCD display-compatible image, which may be previously stored in memory. Without loss of generality, an example of such a compression algorithm would be the JPEG compression algorithm, or the compression of the image by a hadamard matrix decomposition, or other suitable compression algorithm that results in the suitable compression of the image, such that when decompressed, 322, it results in an acceptable image on the WCD, 323, for users. During the registration of the WCD, 404, on the wireless network, represented by the protocol used on the wireless transmission of packets over the link, 318, by the wireless base station, 403, the WCD, 404, can inform the network and subsequently the server, 402, of various information that would assist the server, 402, in assessing the best compression algorithm to use, the format of the display screen, 323, on the WCD, 404, and other information that would be relevant to the quality of the rendering of the information after compression and decompression in processes 315 and 322.

In addition, the wireless server processor comprises processes for encrypting and decrypting the image, which may have been previously stored in memory or received from the base station. The wireless server, 402, could be made aware of the target WCD, 404, characteristics such as its ESN number or other address on the network, as might be understood and managed by the network protocol, such as 802.11, GPRS, 1xRTT, etc. The server could use this address information and/or other information, such as the apriori knowledge of a secret stored serial number or other encryption code on the WCD, 404, which was recorded in private before the WCD was deployed, or could use a public key system, such as is well known to those studied in the art, to encrypt the image with a robust encryption such that if the image transmission to the WCD were intercepted, it would be difficult or impossible to decipher.

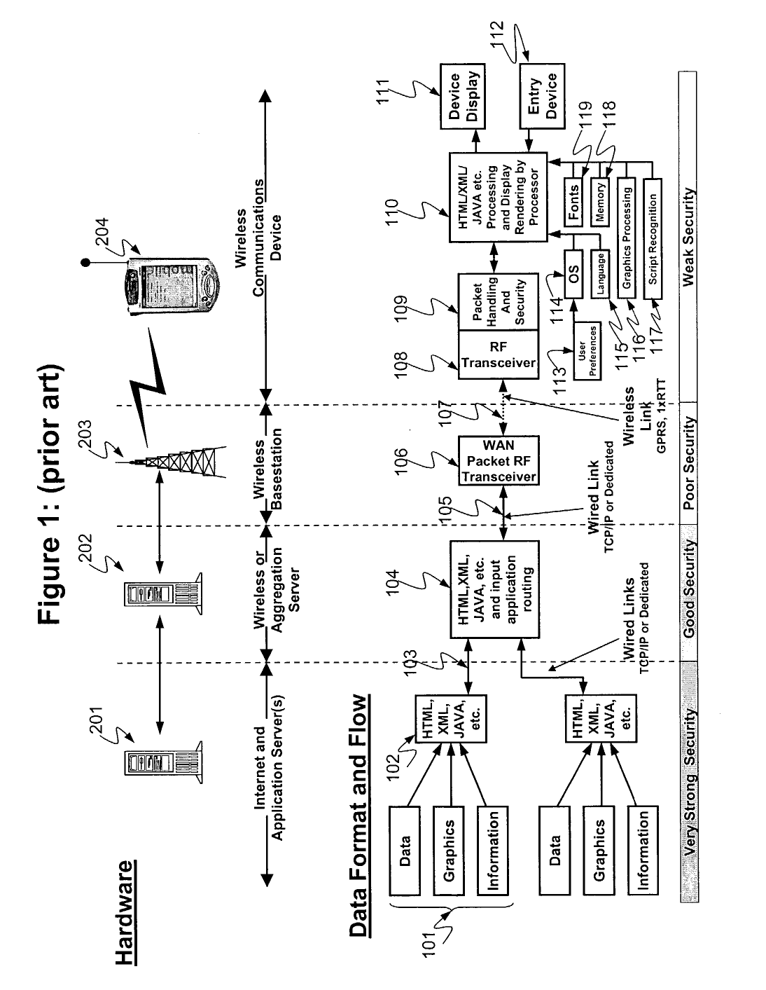

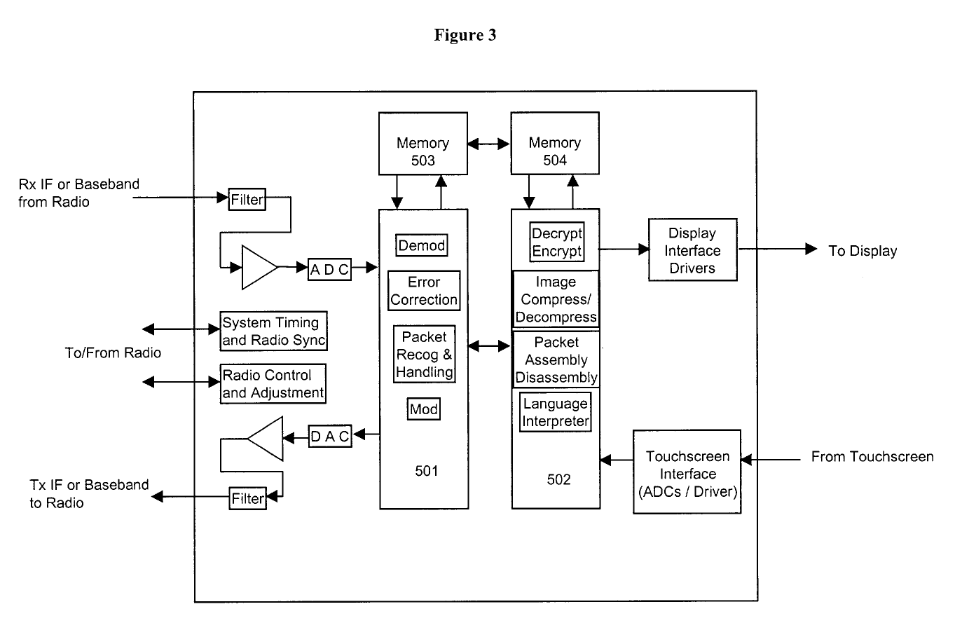

The WCD, 404, coupled to the basestation, 403, using a wireless link, 318, to receive packets over the wireless network, comprises a device display, 323, and a touchpad entry device, 324. The WCD comprises a transceiver, 319, and a first processor for wireless protocol processing, 320, as in the prior art. Additionally, the WCD comprises a second processor, 322, capable of processing data for display, image decompression, and touchscreen compression. Because the processor, 322, has fixed compression/decompression and rendering capabilities, it can be made into fixed hardware on the WCD. The functionality of the WCD, including wireless protocol processing, image compression/decompression, and security, can all be fixed into a single system hardware. In one embodiment of the invention, the system hardware comprises a single chip coupled to a transceiver for sending and receiving the WCD display-compatible data, wherein the single chip comprises a first module for wireless protocol processing, and a second module coupled to the first module for compressing/decompressing and encrypting/decrypting of the WCD display-compatible data. For example, FIG. 3 illustrates the embodiment wherein the wireless protocol processor, 501, and the compression/decompression and encryption/decryption processor, 502, are on a single chip. The WCD now no longer needs general purpose processing and significant reference information and memory as in FIG. 1, 204, but instead needs only a very specific and not general capability of processing of compressed images in order that it may now render literally any type of information that might be conceived, so long as the wireless server, 402, has the processing power to convert the information, data, language etc. into a compressed image.

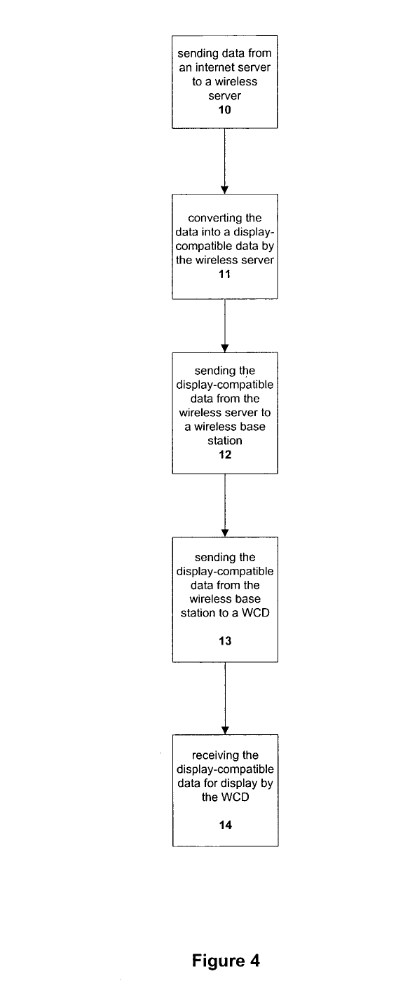

FIG. 4 illustrates a general flowchart of a method for transmitting data from a network server to a WCD. Data, graphics or other information, i.e. FIG. 2 301, which is desired to be provided to the user of a WCD, and which resides on a network server, is formatted as previously into an appropriate internet-compatible format, such as HTML, XML, Java, Flash, etc, by the processor in the network server. The internet-compatible data is then sent 10 to a wireless server over a suitable connection, for example a wired internet connection, i.e. FIG. 3 303. The wireless server, instead of simply routing the packetized information onward, now duplicates to large extent the processing that was formerly done by the WCD, 204, in FIG. 1. As the ultimate goal of any packet transfer of information is to render a recognizable or understandable display to an end user, composed of graphics, text or other information in human-readable form, the present invention teaches that such rendering can be done prior to the transmission to the WCD over the wireless link. The wireless server converts 11 the internet-compatible data into a WCD display-compatible data, for instance a matrix of pixel values, or more generally into an image suitable for a multitude of types of displays on various WCDs, completely on the wireless server, using, as depicted in FIG. 2, the operating system, 307, language information, 308, font information, 312, graphics figures and capabilities, 309 and user preferences, 311, and any other relevant and/or necessary information or processing as might be required to create an image, as would be obvious to those practiced in the art of graphics generation from internet and computer interface protocols and languages. The processing and resulting image, or images, make use of the powerful processor in the wireless server and the accompanying more powerful operating system, 307, and the accompanying additional and faster memory, 313, to store the resultant image in memory, 313, for further processing as described below.

In addition, a function is added which is the compression of the image previously stored in memory with a suitable compression algorithm. Without loss of generality, an example of such a compression algorithm would be the JPEG compression algorithm, or the compression of the image by a hadamard matrix decomposition, or other suitable compression algorithm that results in the suitable compression of the image, such that when decompressed, it results in an acceptable image on the WCD for users. During the registration of the WCD on the wireless network, represented by the protocol used on the wireless transmission of packets over the link, 318, by the wireless base station, 403, the WCD can inform the network and subsequently the wireless server of various information that would assist the wireless server in assessing the best compression algorithm to use, for instance the format of the display screen, 323, on the WCD and other information that would be relevant to the quality of the rendering of the information after compression and decompression.

Additionally, since the image stored in memory might contain sensitive information, such as a bank account balance or other personal data, a method of encryption can also be implemented between the wireless server and the WCD. The wireless server could also be made aware of the target WCD, characteristics such as its ESN number or other address on the network, as might be understood and managed by the network protocol, such as 802.11, GPRS, 1xRTT, etc. The server could use this address information and/or other information, such as the apriori knowledge of a secret stored serial number or other encryption code on the WCD which was recorded in private before the WCD was deployed, or could use a public key system, such as is well known to those studied in the art, to encrypt the image with a robust encryption such that if the image transmission to the WCD were intercepted, it would be difficult or impossible to decipher. The encryption algorithm that is previously negotiated over the wireless network or previously decided in private is also executed on the wireless server. The whole operation of rendering the graphic display, complete with fonts, graphics and other relevant display characteristics, and the encryption of the image, and the compression of the image, can all be performed very quickly on the wireless server. Furthermore, the wireless server can be easily made to have enough power, memory and other resources to serve many WCDs at once.

Still referring to FIG. 4, once the image is generated, compressed and encrypted with suitable error correction coding as well, if necessary, the results in memory, 313, are sent 12 to the wireless base station server, 403, and transmitter, 403, for transmission 13 to the WCD according to the suitable protocol employed for the wireless packet network, such as 802.11, GPRS, 1xRTT, etc, 318.

The WCD then receives the packets containing the compressed image with receiver, 319. Because the image that was compressed by the wireless server is decompressed with a fixed algorithm which is generally quite simple to make into fixed hardware, and since the image is a self contained display of everything that is desired to be shown on the WCD for a particular screen or application, the minimum processing done by the WCD is packet composition and display 14 on the screen. The WCD now no longer needs general purpose processing and significant reference information and memory as in FIG. 1, 204, but instead needs only a very specific and not general capability of processing of compressed images in order that it may now render literally any type of information that might be conceived, so long as the wireless server has the processing power to convert the information, data, language etc into a compressed image.

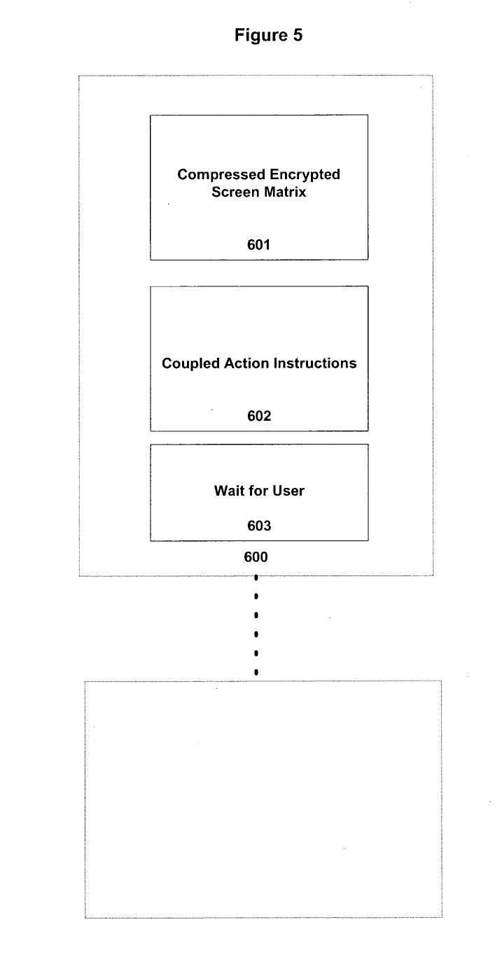

If necessary, the WCD display-compatible data is decrypted, recomposed and decompressed by the WCD in processor 322, and it can then be displayed 14 on the WCD display, 323. It is possible, also without loss of generality, to load more than one screen at a time with very little cost in memory on the WCD, because the image is compressed. It is further possible to define a simple image-action language which is far simpler than the typical internet interface languages and which does not require an operating system, that causes screen images to be loaded or requested from the wireless or network server, 402 or 401, by the user of the WCD when certain positions on a touchscreen overlaying the image are touched. In one example of such a language, referring to FIG. 2, an image sent to the WCD can come with a simple set of instruction such that if certain positions on the display screen, 323, overlayed by touchscreen, 324, are touched, the local processor, 322, can cause a loading into the display device, 323, of a locally stored or remotely stored screen, a recordation of the user touchpoint and return of data to the wireless server, etc. To continue in the vein of this example, FIG. 5 illustrates a general block diagram of the contents of packets containing WCD display-compatible data that would comply with such a language. In this embodiment, each module, 600, comprises a compressed and/or encrypted screen matrix, 601, a set of potential action instructions, 602, and a set of action instructions, 603. For example, if the screen matrix, 601, represents to the user options or requests for other input, then the set of potential action instructions, 602, instruct the WCD on which new images to load if the user touches certain areas on the WCD touchscreen.

Furthermore, these modules typically consume 256 to 2048 bytes, enabling loading of multiple modules into a WCD at once.

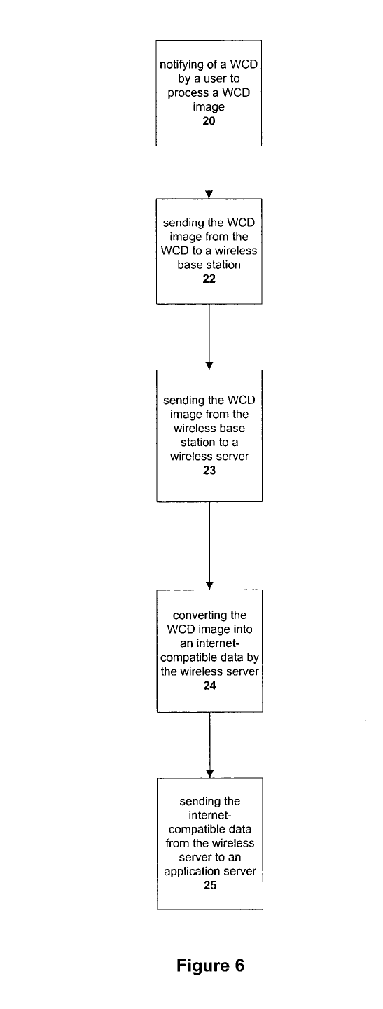

FIG. 6 is a flow-chart illustrating a method for information to go from the user employing a WCD to the wireless server. The user creates an image on the WCD using a touchscreen, 324, which may be the same or different than the display screen, 323, or may use a keypad or other entry device, to create an image with information to be sent to the wireless server or possibly to other users on a network elsewhere, or possibly even other users of WCDs on another wireless network. The image may be created by using a stylus to write on the touchscreen, which may have already as part of the image either nothing (a clean screen) or may contain previously viewed information, such as a form, which become part of the new created image along with additional information written by the user. The composition of the image may also be as simple as one or more touchpoints on the screen, registered by the touchscreen entry device, 324.

In the case where a previously loaded image also came with instructions to branch to other images, or take other simple actions, when a specific or multiple spots on the touchscreen overlaying the image are touched, the WCD could display the branched-to image by either retrieving it as addressed from a small local memory (not shown) or could request it from the wireless or network server(s), 402 or 401.

In the case where a user of the WCD desires to create a new piece of information, such a message or a signature, the processor records writing, printing or touches on the touchscreen, 324, can be recorded into a small local memory. In addition, instead of writing or creating a new image by hand alone, the user may employ locally stored images of characters or other relevant graphics that might be common to many uses and functions which are stored in the local memory of the WCD which might be accessible by a menu and shown on the display device, 323 and selected on the touchscreen, 324. Typical uses of WCDs for interacting with a network server containing useful information rarely require more than a few character response, or selection from a menu of actions or other information to be displayed. Thus the user can employ the WCD to provide short responses of touch points corresponding to menu selection or short strings of characters to the network server, 401, via a simple a simple image-action language. FIG. 5 illustrates a general block diagram of the contents of packets containing WCD display-compatible data that would comply with such a language. In this embodiment, each module, 600, comprises a compressed and/or encrypted screen matrix, 601, a set of potential action instructions, 602, and a set of action instructions, 603. For example, if the screen matrix, 601, represents to the user options or requests for other input, then the set of potential action instructions, 602, instruct the WCD on which new images to load if the user chooses on the WCD touchscreen touchpoints that represent those options.

In another embodiment, the user's response is more complex than a few characters or touch points, such as when the user desires to author a message in natural language writing or include non-text or non-language (i.e. a heart or a smiley face). The user can send the message to the network server, 401, or to other users connected to the wireless server, 402. If the user desires to send the message to the network server, the wireless server, upon receiving and composing the wireless packets, can perform script recognition on the decompressed, decrypted WCD image to construct the relevant internet-compatible data for sending to the network server. In another embodiment, if a first user receives a WCD image from a second WCD user, the first user can write over the WCD image and send the altered image to the second WCD user.

When the user has created a new image using one or more of the methods described above, and when the user notifies 20 the WCD hardware that it is ready to send the new image to the wireless server the image is compressed using the same or similar image compression algorithm by the hardware on the WCD, 322. The compressed image is then decomposed into packets appropriate for the protocol of transmission, 318, and security encryption is added as well, 320, and the image is transmitted 22 by the transceiver, 319, to the basestation, which then sends 23 the packets to the wireless server. The wireless server then reverses the process by decrypting the packets, assembling them and performing any necessary error correction, and then decompressing the image 24. Depending on the application, the image, now present on the wireless server can be sent directly to the network server, 401, or can have further processing performed on the image on the wireless server. For example, if the user has written an instruction or command to a program, or an address for a message, which needs to be converted into a machine-readable representation, such as ASCII, the wireless server can perform script, text or word recognition on the server of part or all of the image, and thereby convert the necessary parts of the image written in human-readable methods into machine readable code.

In another action that is possible to take by the wireless server when it has received a set of image packets, instead of decompressing the image completely, the server may discover through examination of headers, or partial decomposition of the packets, that the contained image is a message and that the message is intended for a recipient on the network who is also in possession of a WCD capable of decompressing the image itself, as though the image had originated from a network server, 401. Therefore, the server can simply forward the message directly to another WCD device, similar to 404, on the same or other related wireless network, without forwarding all the way back to the network server.

The interaction of a user with a WCD and a network server, 401, can take place in both directions as described above, with variations that do not fall outside the scope of the invention. For example, there may exist several servers and routers between the wireless base station, 403, and the network server, 401, which may convert the packet information into other forms, or which may move the packets over either wired or wireless links along the path described, or which may partially decode headers or other relevant information in order to perform routing and proper handling of the packets.

Optionally, while the WCD user interface, comprising microphone, speaker, keypad, or display, for example, is powered off, wireless data connectivity can continue to operate. For example, text messages intended for the user can continue to arrive, or text messages being sent out by a user can be placed in a queue and sent out automatically. In relation to FIG. 3, data messages received by the RF system while the user interface system is powered down are processed by the baseband system 501 and 502 and then stored in memory 503 or 504. The present embodiment comprises the antenna, the RF system coupled to the antenna, the baseband system coupled to the RF system, the user interface system coupled to the baseband system, as well as a user controlled switch, not shown in FIG. 3, coupled to at least the user interface system, which can be used to power off the user interface systems of the WCD while maintaining power to the rest of the systems. The baseband can keep the communications channel open by reconciling either time slot or long message length, as needed. Thus, battery power is conserved by powering down the user interface, but data can still be sent and received by the WCD. The embodiments of the present invention can be extended to personal computer laptops, personal digital assistants (PDAs), or other wireless personal devices without departing from the spirit of the present invention.

The foregoing described embodiments of the invention are provided as illustrations and descriptions. They are not intended to limit the invention to precise form described. In particular, the Applicants contemplate that functional implementation of the invention described herein may be implemented using a variety of techniques in a wide range of materials systems. Also, the process steps describing the methods may be re-arranged and/or re-ordered. Other variations and embodiments are possible in light of above teachings, and it is thus intended that the scope of invention not be limited by this Detailed Description, but rather by claims following.

I claim:

1. A wireless network apparatus comprising:
one or more wireless communications devices (WCDs) comprising a display;
a base-station coupled to the one or more WCDs; and
a wireless server coupled to the base-station and a network server, wherein the wireless server converts an internet-compatible data from the network server into a WCD display-compatible data, and converts an other WCD display-compatible data from the base-station into an other internet-compatible data.

2. The wireless network of claim 1, wherein the wireless server compresses or decompresses the WCD display-compatible data.

3. The wireless network of claim 1, wherein the wireless server encrypts or decrypts the WCD display-compatible data.

4. The wireless network of claim 1, wherein the WCD compresses or decompresses the WCD display-compatible data.

5. The wireless network of claim 1, wherein the WCD encrypts or decrypts the WCD display-compatible data.

6. The wireless network of claim 1, wherein the WCD comprises a system hardware comprising
a single chip coupled to a transceiver for sending and receiving the WCD display-compatible data, wherein the single chip comprises a first module for wireless protocol processing and a second module coupled to the first module for compressing/decompressing and encrypting/decrypting of the WCD display-compatible data.

7. The wireless network of claim 1, wherein the wireless server receives the WCD display-compatible data from the base-station for sending the WCD display-compatible data to an other WCD using the base-station.

8. The wireless network of claim 1 wherein the WCD display comprises a touchscreen.

9. The wireless network of claim 1 wherein the WCD display-compatible data comprises a compressed and encrypted screen matrix, a set of actions to take by the WCD, and a set of potential action instructions, wherein the set of potential action instructions comprise a set of user options wherein each user option is coupled to a corresponding WCD action instruction.

10. A method for wireless data transmission comprising the steps of:
sending data from a network server to a wireless server;
converting the data into a WCD display-compatible data by the wireless server;
sending the WCD display-compatible data from the wireless server to a base station;
sending the WCD display-compatible data from the base station to a WCD; and
receiving the WCD display-compatible data for display by the WCD.

11. The method of claim 10 comprising the further step of compressing the WCD display-compatible data by the wireless server.

12. The method of claim 10 comprising the further step of decompressing the WCD display-compatible data by the WCD.

13. The method of claim 10 comprising the further step of encrypting the WCD display-compatible data by the wireless server.

14. The method of claim 10 comprising the further step of decrypting the WCD display-compatible data by the WCD.

15. The method of claim 10 wherein the WCD comprises a system hardware comprising a single chip coupled to a transceiver for sending and receiving the WCD display-compatible data, wherein the single chip comprises a first module for wireless protocol processing and a second module coupled to the first module for decompressing and decrypting of the WCD display-compatible data.

16. The method of claim 10 wherein the WCD display-compatible data comprises a compressed and encrypted screen matrix, a set of actions to take by the WCD, and a set of potential action instructions, wherein the set of potential action instructions comprise a set of user options wherein each user option is coupled to a corresponding WCD action instruction.

17. A method of wireless data transmission comprising the steps of:
notifying of a WCD by a user to send a WCD image;
sending the WCD image from the WCD to a base station;
sending the WCD image from the base station to a wireless server;
converting the WCD image into an internet-compatible data by the wireless server; and
sending the internet-compatible data from the wireless server to a network server.

18. The method of claim 17 comprising the further step of compressing the WCD image by the WCD.

19. The method of claim 17 comprising the further step of decompressing the WCD image by the wireless server.

20. The method of claim 17 comprising the further step of encrypting the WCD image by the WCD.

21. The method of claim 17 comprising the further step of decrypting the WCD image by the wireless server.

22. The method of claim 17 wherein the WCD comprises a system hardware comprising a single chip coupled to a transceiver for sending and receiving the WCD display-compatible data, wherein the single chip comprises a first module for wireless protocol processing and a second module coupled to the first module for compressing and encrypting of the WCD display-compatible data.

23. The method of claim 17 comprising the further step of creating the WCD image on the touchscreen by the user, wherein the WCD image comprises a natural language script.

24. The method of claim 23 comprising the further step of performing script recognition on the WCD image by the wireless server.

25. The method of claim 17 comprising the further step of selecting from one or more images on the touchscreen by the user.

26. The method of claim 17 wherein the WCD display-compatible data comprises a compressed and encrypted screen matrix, a set of actions to take by the WCD, and a set of potential action instructions, wherein the set of potential action instructions comprise a set of user options wherein each user option is coupled to a corresponding WCD action instruction.

27. The method of claim 26 wherein a user option from the set of user options comprises the further step of selecting from one or more images on a touchscreen of the WCD by the user.

28. The method of claim 27 comprising the further step of executing the corresponding action instruction coupled to the user option.

29. The method of claim 17 comprising the further steps of:
receiving the WCD image by the wireless server;
sending the WCD image from the wireless server to the base-station; and
receiving the WCD image from the base-station for display by an other WCD.

30. A wireless communications device (WCD) architecture comprising:
a display;
a wireless link coupled to a base-station for sending and receiving a WCD display-compatible data; and
a system hardware for wireless data packet assembly.

31. The WCD of claim 30 wherein the wireless link is coupled to the base-station for sending and/or receiving a compressed WCD display-compatible data.

32. The WCD of claim 30 wherein the wireless link is coupled to the base-station for sending and/or receiving an encrypted WCD display-compatible data.

33. The WCD of claim 30 wherein the system hardware comprises a single chip coupled to a transceiver for sending and receiving the WCD display-compatible data, wherein the single chip comprises a first module for wireless protocol processing of the WCD display-compatible data, and a second module coupled to the first module for compressing/decompressing and encrypting/decrypting of the WCD display-compatible data.

34. The WCD of claim 30 wherein the display comprises a touchscreen entry device.

35. The WCD of claim 34 wherein the WCD display-compatible data comprises a set of coordinates touched on the touchscreen by the user.

36. The WCD of claim 30 wherein the WCD display-compatible data received from the wireless link comprises a compressed and encrypted screen matrix, a set of action instructions and a set of potential action instructions.

37. The WCD of claim 34 wherein the WCD display-compatible data comprises a natural language script drawn on the touchscreen by the user.

38. The WCD of claim 30 further comprising a user controlled switch wherein one of the possible states of operation of the switch comprises a power down state of the display.

39. A wireless server architecture comprising:
a first link coupled to a network server for sending and receiving an internet-compatible data;
one or more processors; and
a second link coupled to a base-station for sending and receiving a WCD display-compatible data, wherein the internet compatible-data received from the first link is converted by the one or more processors into the WCD display-compatible data for sending over the second link, and wherein an other WCD display-compatible data received from the second link is converted by the one or more processors into an other internet-compatible data for sending over the first link.

40. The wireless server of claim 39 wherein the WCD display-compatible data received from the second link is in the form of a natural language script.

41. The wireless server of claim 40 wherein the first processor performs script recognition on the WCD display-compatible data.

42. The wireless server of claim 39 wherein the WCD display-compatible data comprises a compressed and encrypted screen matrix, a set of actions to take by the WCD, and a set of potential action instructions, wherein the set of potential action instructions comprise a set of user options wherein each user option is coupled to a corresponding WCD action instruction, and wherein the WCD action instruction comprises a request for data stored on the wireless server.

43. The wireless server of claim 42 wherein the WCD display-compatible data received from the second link comprises one or more requests for data stored on the wireless server.

44. The wireless server of claim 39 wherein the one or more processors comprises a first and a second processes for image compression and data encryption and a third and a fourth processes for image decompression and data decryption.

45. The wireless server of claim 44 wherein the internet compatible-data received from the first link is converted by the first and second processes into a compressed and encrypted WCD display-compatible data for sending over the second link.

46. The wireless server of claim 44 wherein a compressed and encrypted WCD display-compatible data received from the second link is converted by the third and fourth processes into an other internet-compatible data for sending over the first link.

47. The wireless server of claim 39 wherein the other WCD display-compatible data received from the second link by the wireless server is sent by the wireless server over the second link.

48. The wireless server of claim 39 further comprising a database comprising a set of data pertaining to one or more WCD users.

49. The wireless server of claim 48 wherein the set of data comprises a user preference data set pertaining to one or more WCD users.

50. The wireless server of claim 48 wherein the set of data comprises a compression algorithm data set pertaining to one or more WCD users.
